(19) United States
(12) Patent Application Publication
(10) Pub. No.: US 2010/0257479 A1
(43) Pub. Date: Oct. 7, 2010

(54) Graphical User Interface with Dynamic Toolbar Search Functionality

(75) Inventors: Phuc K. Do, Morrisville, NC (US); Justin M. Pierce, Cary, NC (US)

Correspondence Address: STREETS & STEELE - IBM CORPORATION, 13100 WORTHAM CENTER DRIVE, SUITE 245, HOUSTON, TX, 77065, US

(73) Assignee: INTERNATIONAL BUSINESS MACHINES CORPORATION, Armonk, NY (US)

(21) Appl. No.: 12/416,184

(22) Filed: Apr. 1, 2009

(51) Int. Cl. G06F 3/048

(52) U.S. Cl. 715/780; 715/781; 715/840; 715/825

(57) ABSTRACT

One embodiment provides a computer-implemented method that may be used to facilitate working with the graphical user interface of an application. A plurality of command buttons and toolbars are stored in memory. Each command button includes an associated button description, software function, and icon. Each toolbar includes an associated toolbar description and subset of buttons. A search window is displayed in a graphical user interface. Text input is received at the search window, as entered by a user. The computer-implemented method then searches for and displays command buttons or toolbars in memory matching at least a portion of the text input.

### BACKGROUND OF THE INVENTION

1. Field of the Invention

The present invention relates generally to graphical user interfaces, and more particularly to the management and use of toolbars and command buttons.

2. Background of the Related Art

Menus and toolbars are common features of a graphical user interface for working with modern software applications. However, as the features and functionality of software continue to become more robust, the graphical user interfaces associated with some applications are becoming increasingly complex. Due to the extensive on-screen real-estate that would be required to simultaneously display all of an application's commands, some applications have dozens of separate toolbars that may be selectively hidden at any given time. A toolbar is a collection of command buttons or icons that are typically related to a common function or task. Some applications provide only fixed toolbars, as defined by the applications, while other applications allow for user-defined or at least user-customizable toolbars.

One common approach that simplifies how a user interacts with a graphical user interface includes selectively displaying only a limited number of toolbars at any given time. Accordingly, the user may display the most common toolbars during a particular software session or series of sessions, and only expose additional toolbars as needed. Another approach to simplifying a graphical user interface is used in Microsoft® Word 2007, which provides a “ribbon” design having one large toolbar that changes according to user task. However, even when using the ribbon design toolbar, it can still be difficult for a user to locate desired icons and determine their functionality.

### BRIEF SUMMARY OF THE INVENTION

One embodiment of the present invention provides a computer-implemented method, in which a plurality of command buttons is stored in memory. Each command button includes an associated command button description, software function, and icon. A search window is displayed in a graphical user interface. Text input is received at the search window. One or more of the command buttons in memory are identified that match at least a portion of the text input. One or more icons are displayed in the graphical user interface, wherein each displayed icon is associated with one or more of the identified command buttons.

### BRIEF DESCRIPTION OF THE SEVERAL VIEWS OF THE DRAWINGS

FIG. 1 is a diagram of a computer system for implementing a method according to an embodiment of the invention.

FIG. 2 is a flowchart generally outlining a method of searching for matching buttons and toolbars.

FIG. 3 is a screenshot of the application window illustrating an example search wherein buttons are included in the search results box.

FIG. 4 is a screenshot of the application window illustrating another example search, wherein predefined toolbars are included in the search results box.

### DETAILED DESCRIPTION OF THE INVENTION

One embodiment of the present invention provides a computer implemented method for quickly locating and accessing command buttons and toolbars associated with an application. Predefined toolbars and individual command buttons may be stored in libraries in computer memory. The predefined toolbars and buttons can be located and accessed in a conventional manner, using a hidden menu structure of the application. Additionally, the application may expose a search bar for performing text-based searches to locate the desired toolbars and command buttons. The search bar includes a search window for receiving text input and a search results box for displaying the search results. A search logic module receives text input to the search window and applies a search protocol to find one or more matching or relevant command buttons in the command button library or one or more matching or relevant toolbar in the toolbar library. The matching or relevant command buttons and/or toolbars are displayed in the search results box, and are operable directly from the search results box. The command buttons or toolbars resulting from a search can be used directly from within the search results box, or they can exist as separate (docked or floating) toolbars that are independent of the search bar. This provides an extremely flexible and fast method for customizing a graphical user interface that is particularly well-suited for task-oriented work.

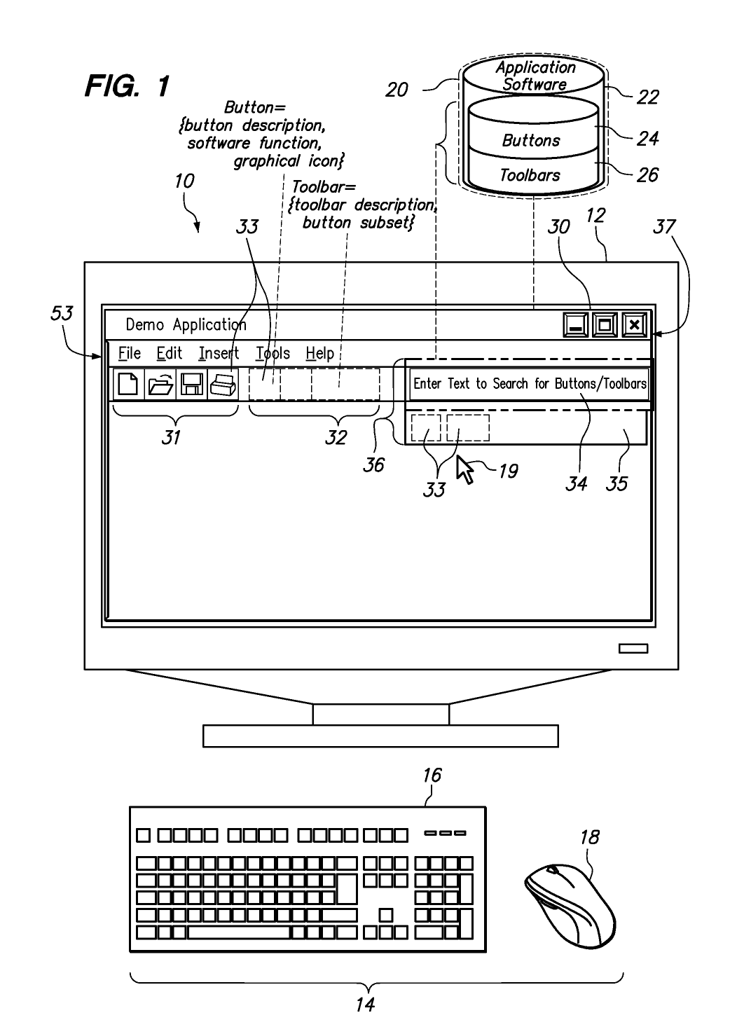

FIG. 1 is a diagram of a computer system 10 for implementing a method according to an embodiment of the invention. The computer system 10 includes a display 12, user input devices 14, and memory 20. By way of example, the display 12 is drawn to resemble the flat-panel display of a personal computer (PC), and the user input devices 14 are drawn to resemble a PC-type keyboard 16 and a mouse 18. In the case of a PC or laptop computer, the operating system for the computer system 10 typically includes software code in the form of device drivers for controlling the keyboard 16, mouse 18, or other user input devices 14. Also in the case of a PC, the memory 20 will typically include long-term storage such as one or more hard discs or a flash-based drive, where the application software 22 is installed and remains when the computer system 10 is powered off. The memory 20 also typically includes system memory, including one or more dual in-line memory modules (DIMMs), where instructions included with the application software 22 may be loaded from long-term storage and directly accessed by a processor (CPU) during execution of the instructions. The computer system 10 may alternatively be an electronic device other than a PC, capable of running the application software 22 and having a suitable version of a display, user input devices, and memory. Examples of such other electronic devices include personal digital assistants (PDAs) and smart-phones.

The application software 22 is responsive to user input via the user input devices 14 and generates visual output via the display 12. In particular, the application software 22 generates a graphical user interface (GUI) including graphical icons and visual indicators, in addition to text, on the display 12. Here, the GUI includes an application window 30. The application window 30 is a visual area, optionally rectangular in shape, displaying the output of and receiving user input to the application software 22. The application window 30 may be manipulated with a pointer 19, the movement of which is typically controlled by the mouse 18 or other pointing device, or by the keyboard 16. The application window 30 can be resized, moved, hidden, restored, minimized, maximized, and closed using windows resizing controls 37. The application window 30 is currently shown maximized, thus filling the viewable display area of the display 12. Additional windows may also be displayed simultaneously with the application window 30. In the present view, any other application windows that may be open are hidden behind the maximized application window 30.

Interactive features of the application window 30 include a predefined toolbar 31, a dynamic toolbar 32, and a search bar 36 that includes a search window 34 and a search results box 35. The predefined toolbar 31 is one of a plurality of predefined toolbars from a toolbar library 26 stored in memory 20 as part of the application software 22, while the dynamic toolbar 32 may be created in response to a search by a user on an as-needed basis, as explained further below. The predefined toolbar 31 and dynamic toolbar 32 each include a subset of command buttons 33 selected from a command button library 24 stored in memory. Each toolbar is defined by a set of toolbar parameters {toolbar description, command buttons} and each command button is defined by a set of button parameters {command button description, software function, icon}. A command button library 24 containing all of the command buttons available to the application software 22 and a toolbar library 26 containing all of the toolbars available to the application software are stored in memory 20. The command buttons and toolbars available to the application software 22 are generally too numerous to display simultaneously on the display 12. Thus, it is typically the case that only a limited selection of the available toolbars and command buttons are displayed at any one time.

Each command button, which may be simply referred to as a “button,” is a user interface element that provides the user a way to perform a software function, such as triggering the execution of a command. Here, each button 33 is defined by its unique set of parameters that include the associated button description, software function, and graphical icon (referred to simply as an “icon”). The button description may include a button name, which is a name used to reference the button. The button name commonly has a tangible relationship to the associated software function, such as “copy,” “paste,” or “save file.” The button description may further include descriptive verbiage, optionally embedded with metadata, which may facilitate searching for buttons as described below. The software function associated with a button 33 is handled by a defined segment of program code or a set of instructions inside the application software 22. The icon associated with a button is a graphical element, which usually includes a symbol or design, but may also include text. A unique icon is usually assigned to each button, which allows a user to visually identify the software function associated with a button and visually distinguish between different buttons. For example, a button used to save an active file may be given the button name “save” and have an icon that resembles a “floppy disk,” which was once a common storage medium for saving files.

The software function associated with a selected button 33 may be triggered by “pressing” the selected button 33. A user may press a selected button 33 using the user input devices 14. For example, the user may move the mouse 18 or other pointing device to position the pointer 19 over a selected button 33, or alternatively using cursor control buttons on the keyboard 16. With the pointer 19 positioned over the selected button 33, the user may press the selected button 33 in the display 12 by “clicking on” a physical button on the mouse 18 (not to be confused with the selected button 33 in the display window 30). It may also be possible to press the selected button 33 using controls on the keyboard 16, such as by “tabbing” to the selected button 33 or using cursor control keys to position the pointer 19 over the selected button 33, and striking a physical key (e.g., the ‘Enter’ key) on the keyboard 16.

Predefined toolbars typically include buttons for performing a related set of tasks, and may be given toolbar names that reflect the related set of functions. For example, the illustrated predefined toolbar 31 may have the toolbar name “Standard,” and includes (from left to right) a “New Document” button, an “Open File” button, a “Save” button, and a “Print” button. Another example of a predefined toolbar (not shown) may contain buttons used to edit a document in the application window 30, and may be referred to as the “Edit” toolbar. Examples of buttons that may be included with an Edit toolbar are “Cut,” “Paste,” “Undo,” and “Redo” buttons. A predefined toolbar may also include a toolbar description, optionally embedded with metadata or as metadata. The toolbar description may include the toolbar name, as well as descriptive verbiage used to facilitate searching for the predefined toolbar as described below.

The predefined toolbar 31 may be a fixed, application-defined toolbar, or may be customizable to a limited extent. For example, a user may use the input devices 14 to access a menu bar 53 for accessing a hidden menu substructure in the application window 30, and navigate the hidden menu substructure to locate and select a toolbar editing application known in the art (not shown). Alternatively, the user may access a context menu, such as by right-clicking the predefined toolbar 31, to locate the toolbar editing application from a limited set of menu choices in the context menu. In the toolbar editing application, the user can view a list of available buttons from the button library 24 and “drag/drop” buttons to or from the predefined toolbar 31. Predefined toolbars are useful in working with the application software 22, as they commonly include a handy set of buttons that are routinely used by computer users. However, the toolbars and their respective buttons may be too numerous for most users to easily recall in which toolbar a desired button is located. The process of customizing the predefined toolbar 31 or manually exploring the button library 24 and toolbar library 26 takes considerable effort and time, and often requires the user to hunt through an extensive list of button categories and sub-categories to locate the desired button.

To facilitate locating and using the various buttons and toolbars stored in memory 20, the application software 22 generates a search window 34 in the application window 30 that enables the user to quickly search and locate one or more buttons and/or toolbars that are not already displayed in the application window 30. The search window 34 provides a simple, fast, and convenient way to locate particular buttons or toolbars without the complication of manually customizing the predefined toolbar 31. The search window 34 may be a child window within the parent application window 30 where a user can input text to search for buttons and/or toolbars. The user can use the mouse 18 to move the pointer 19 over the search window 34, and click or otherwise select the search window 34, and then enter text into the search window 34 using the keyboard 16. The application software 22 then searches for any buttons in the button library 24 or toolbars in the toolbar library 26 that match or relate to the entered text or portion thereof. Whether a particular button or particular toolbar matches or relates to the text may be determined by comparing the search text to the associated button description and toolbar description, respectively. Matching buttons or toolbars may be displayed in the search results box 35 or exist separately, such as in the dynamic toolbar 32.

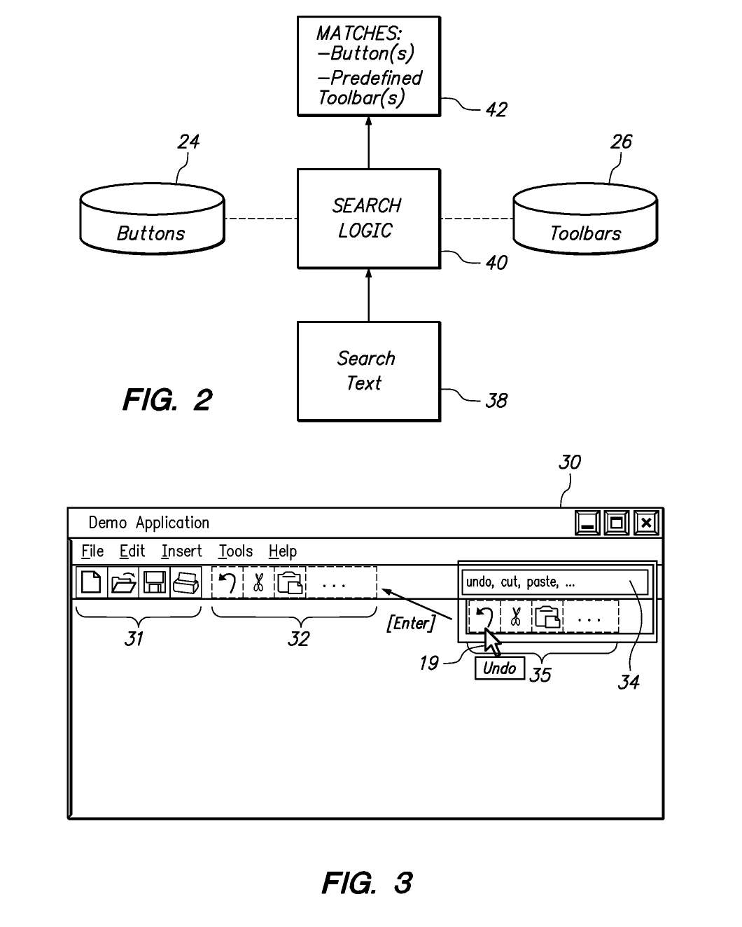

FIG. 2 is a diagram generally outlining a method of searching for buttons and toolbars that may be implemented by application software (e.g. application software 22 of FIG. 1) according to an embodiment of the invention. A search logic module 40 included with a software application searches the button library 24 and toolbar library 26 for any button or toolbar that matches or relates to the search text 38. Search results 42 may include one or more buttons and/or toolbars. More particularly, the search logic module 40 may search the button library 24 for buttons having a button description matching at least a portion of the text input at the search window 34. The search logic module 40 may also search the toolbar library 26 for toolbars having a toolbar description matching at least a portion of the text input at the search window 34. In one embodiment, the search results may include any toolbar having a button that matches the search text 38. In another embodiment, the search results may display buttons or toolbars in order of their relevance to the search text 38.

The search logic module 40 may incorporate an existing text-based search protocol for performing text-based searches, uniquely adapting the search protocol to searching for buttons and toolbars based on their respective button descriptions and toolbar descriptions. For example, the search logic module 40 may incorporate “natural language” search protocol for attempting to locate buttons or toolbars suggested by ordinary phrases (as opposed to formal phrases) a user might enter in an attempt to locate a suitable button or toolbar. For instance, the search results 42 for the natural language phrase, “I want to clip text and paste it” might result in a “cut” button, a “paste” button, and/or an “Edit” toolbar as suggested matches. An alternative search protocol may instead use terms and term-connectors (e.g. AND, OR, NOT, etc.) in searching for toolbars and buttons. For instance, the search phrase “cut AND paste” may generate and display a dynamic toolbar including the “Cut” button and the “Paste” button from the button library 24, or the search phrase may instead locate and display a predefined “Edit” toolbar in the toolbar library 26 that is predefined to include the Cut and Paste buttons.

In one embodiment or according to specified user settings, the search logic module 40 may search for only exact matches. In another embodiment or alternate user settings, the search logic module may instead look for closely matching button names or toolbar names, even though an exact match might not be obtained. The former may produce more precise search results. The latter may be more forgiving of a user's misspellings or “guesses” at what the button name or toolbar name might be, and may generate a list of possible (although inexact) matches, optionally sorted by relevance or degree of match.

The descriptive verbiage included with the button description in the form of metadata could be utilized to improve the results of the search. For example, in one embodiment, a search for the term “undo” may return the pair of buttons “undo” and “redo” by virtue of the very close relationship of the two buttons. Further, the metadata could help the search bar results arrange themselves logically and combine information to further improve results. For example, when searching the phrase “stderr, avg”, the metadata in the “stderr” and “avg” buttons may contains rules that, when combined, suggest to the search logic module 40 that the user is working with statistics—thus returning a statistics toolbar in the search results.

FIG. 3 is a screenshot of the application window 30 illustrating an example search wherein buttons are included in the search results box 35. Text has been entered into the search window 34, with portions of text separated by a comma as a delimeter. An alternate delimeter, such as a semicolon, may be used instead of a comma. In this example, the three comma-separated portions of text happen to be (but are not required to be) exact button names: undo, cut, and paste. As the text is typed into the search window 34, the application software parses the text input to identify the delimited portions of the text input, and the search results box 35 is dynamically updated to include the matching undo, cut, and paste buttons. Thus, if an additional term were typed following the comma after “paste,” a button name or button description matching the additional term may be added next to the three undo, cut, and paste buttons currently displayed.

The buttons displayed in the search results box 35 may be operable directly from the search results box 35. For example, the pointer 19 is shown hovering over the “undo” button as it appears in the search results box 35, and a balloon appears identifying the button name “undo.” With the pointer 19 positioned as shown, the undo button may be clicked directly from its location in the results box 35 to perform the “undo” software function. An example of when a user may want to work directly from the search results box 35 is when the user intends to quickly locate the desired button for a single use.

Alternatively, the dynamic toolbar 32 may exist independently of the search results box 35. For example, the user may want the searched-for buttons to be available on an extended basis, such as for the duration of a session or for multiple sessions with the application software. In that case, the user may invoke an action to “send” the buttons in the results box 35 to the dynamic toolbar 32 visually separated from the search window 34. For example, as illustrated, pressing “Enter” on a keyboard moves the searched-for buttons from the results box 35 to the dynamic toolbar 32. The dynamic toolbar 32 may be in a docked position, as shown, or in a free-floating position. The dynamic toolbar 32 may remain in the application window 30 every time the application software is run, unless and until the dynamic toolbar 32 is modified, moved, or removed by the user. User settings may be provided to control this functionality.

The buttons in the results box 35 may appear in the search results box 35 in the order in which they are searched. When sent to one or more dynamic toolbars, the buttons may be arranged categorically. Buttons corresponding to a particular category or related set of functions may be arranged in one dynamic toolbar 32, while buttons corresponding to another category or related set of functions may appear in a different dynamic toolbar (not shown). For example, if the search results box 35 includes a paste button and an oval button, the “paste” button may be sent to one dynamic toolbar related by “Edit” tasks, and the “oval” button (not shown) may be sent to another dynamic toolbar related by “Drawing” tasks.

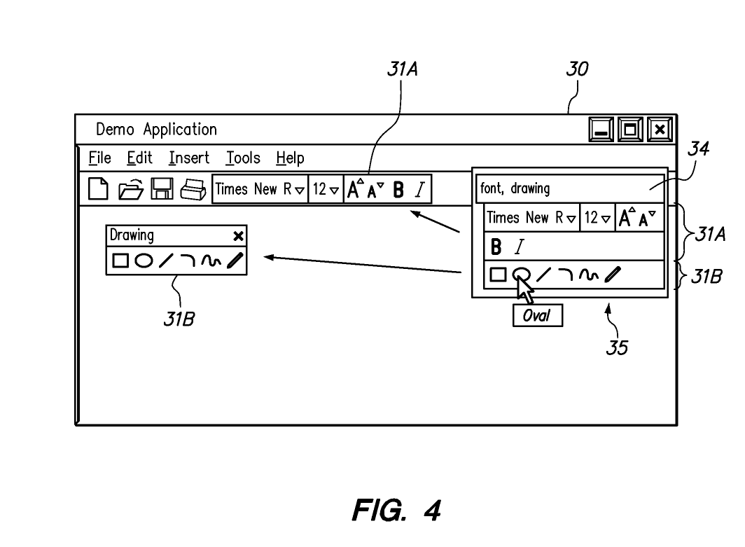

FIG. 4 is a screenshot of the application window 30 illustrating another example search, wherein predefined toolbars are included in the search results box 35. In this example, the comma-separated portions of text input at the search window 34 are identified by the application software as matching the predefined “Font” toolbar 31A and “Drawing” toolbar 31B. The predefined Font and Drawing toolbars 31A, 31B appear in the search results box 35. (The Font toolbar 31A is shown “wrapped” onto two lines to conform to the boundaries of the search results box 35). The user may work directly with the predefined toolbars 31A, 31B as they appear in the search results box 35. Alternatively, the user may “send” the predefined toolbars 31A, 31B to a docked or floating position within the application window 30, as shown, where the predefined toolbars 31A, 31B may remain indefinitely (e.g. for the duration of the session or for multiple sessions). For example, the Font toolbar 31A is shown as sent to a docked position in the upper pane of the application window 30. The Drawing toolbar 31B is shown as sent to a floating position, where it can be optionally closed by clicking the “X” in the upper right corner of the floating Drawing toolbar 31B.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method, comprising:
storing a plurality of command buttons in memory, each command button including an associated command button description, software function, and icon;
displaying a search window in a graphical user interface;
receiving text input at the search window;
identifying one or more of the command buttons in memory that match at least a portion of the text input; and
displaying one or more icons in the graphical user interface, wherein each displayed icon is associated with one or more of the identified command buttons.

2. The computer-implemented method of claim 1, further comprising dynamically updating the search while receiving the text input at the search window.

3. The computer-implemented method of claim 1, further comprising:
displaying an interactive application window of a software application in the graphical user interface and displaying the search window as a child window of the interactive application window; and
executing the software functions associated with the matching command buttons using code of the software application.

4. The computer-implemented method of claim 1, further comprising:
parsing delimeter-separated portions of the text input; and
searching for a matching command button for each delimeter-separated portion of the text input.

5. The computer-implemented method of claim 1, further comprising:
storing a plurality of predefined toolbars in memory, each predefined toolbar including an associated toolbar description and subset of the command buttons;
searching for predefined toolbars in memory matching at least a portion of the text input; and
displaying the matching toolbars in the graphical user interface.

6. The computer-implemented method of claim 5, further comprising:
parsing delimeter-separated portions of the text input; and
searching for a matching command button or matching toolbar for each delimeter-separated portion of the text input.

7. The computer-implemented method of claim 1, further comprising:
displaying the matching command buttons in a search results box of the graphical user interface, wherein the matching command buttons are operable directly from the search results box.

8. The method of claim 7, further comprising displaying the matching command buttons in the search results box in the order in which the command buttons were searched for.

9. The computer-implemented method of claim 7, further comprising, in response to a user action, displaying the matching command buttons in a dynamic toolbar visually separated from the search results box wherein the matching command buttons are also operable from the dynamic toolbar.

10. A computer program product including computer usable program code embodied on a computer usable medium, the computer program product including:
computer usable program code for storing a plurality of command buttons in memory, each command button including an associated command button description, software function, and icon;
computer usable program code for displaying a search window in a graphical user interface;
computer usable program code for receiving text input at the search window;
computer usable program code for searching for command buttons in memory matching at least a portion of the text input; and
computer usable program code for displaying the matching command buttons in the graphical user interface.

11. The computer program product of claim 10, further comprising computer usable program code for dynamically updating the search while receiving the text input at the search window.

12. The computer program product of claim 10, further comprising:
computer usable program code for displaying an interactive application window of a software application in the graphical user interface and displaying the search window as a child window of the interactive application window; and
computer usable program code for executing the software functions associated with the matching command buttons using code of the software application.

13. The computer program product of claim 10, further comprising:
computer usable program code for parsing delimeter-separated portions of the text input; and
computer usable program code for searching for a matching command button for each delimeter-separated portion of the text input.

14. The computer program product of claim 10, further comprising:
computer usable program code for storing a plurality of predefined toolbars in memory, each predefined toolbar including an associated toolbar description and subset of the command buttons;
computer usable program code for searching for predefined toolbars in memory matching at least a portion of the text input; and
computer usable program code for displaying the matching toolbars in the graphical user interface.

15. The computer program product of claim 14, further comprising:
computer usable program code for parsing delimeter-separated portions of the text input; and
computer usable program code for searching for a matching command button or matching toolbar for each delimeter-separated portion of the text input.

16. The computer program product of claim 10, further comprising:
computer usable program code for displaying the matching command buttons in a search results box of the graphical user interface, wherein the matching command buttons are operable directly from the search results box.

17. The computer program product of claim 16, further comprising computer usable program code for displaying the matching buttons in the search results box in the order in which the command buttons were searched for.

18. The computer program product of claim 16, further comprising computer usable program code for, in response to a user action, displaying the matching command buttons in a dynamic toolbar visually separated from the search results box wherein the matching command buttons are also operable from the dynamic toolbar.
